(19) United States
(12) Patent Application Publication
(10) Pub. No.: US 2012/0248318 A1
(43) Pub. Date: Oct. 4, 2012

(54) RADIOGRAPHIC IMAGE-PICKUP DEVICE AND RADIOGRAPHIC IMAGE-PICKUP DISPLAY SYSTEM

(75) Inventors: Ryoichi Ito, Aichi (JP); Tsutomu Tanaka, Kanagawa (JP); Yasuhiro Yamada, Aichi (JP)

(73) Assignee: Sony Corporation, Tokyo (JP)

(21) Appl. No.: 13/424,739

(22) Filed: Mar. 20, 2012

(30) Foreign Application Priority Data
Mar. 30, 2011 (JP) 2011-076516

(51) Int. Cl. G01T 1/20

(52) U.S. Cl. 250/361 R

(57) ABSTRACT

A radiographic image-pickup device includes: a photoelectric conversion layer; a wavelength conversion layer provided on the photoelectric conversion layer and converting a wavelength of radiation into a wavelength within a sensitivity band of the photoelectric conversion layer; and a low-refractive-index layer provided between the photoelectric conversion layer and the wavelength conversion layer, and having a refractive index lower than a refractive index of each of the photoelectric conversion layer and the wavelength conversion layer.

### BACKGROUND

The present disclosure is related to a radiographic image-pickup device and a radiographic image-pickup display system that are preferable for use in X-ray photography for medical and nondestructive inspection applications for example.

In recent years, a radiographic image-pickup device that obtains an image as an electric signal without using any photographic film (performs image-pickup by photoelectric conversion) has been developed as a radiographic image-pickup device using radiation such as X-rays (for example, refer to Japanese Unexamined Patent Application Publication No. 2004-45420 and Japanese Unexamined Patent Application Publication No. 2003-215255). An example of such a radiographic image-pickup device includes so-called an indirect conversion type radiographic image-pickup device having a scintillator on a pixel substrate incorporating photoelectric conversion elements such as a photodiode.

### SUMMARY

On the indirect conversion type radiographic image-pickup device as stated above, however, when the scintillator is mounted directly on the pixel substrate, the optical absorption index deteriorates due to optical loss resulting from interface reflection as compared with a case where no scintillator is provided (a case where light comes into a photoelectric conversion element via an air layer). Alternatively, as disclosed in Japanese Unexamined Patent Application Publication No. 2004-45420, even when the photoelectric conversion element is covered with a protection film (single SiN layer), and the scintillator is laminated on the protection film, there is a disadvantage of deterioration in the optical absorption index as with a case where the scintillator is mounted directly.

It is desirable to provide a radiographic image-pickup device and a radiographic image-pickup display system that are capable of suppressing deterioration in the optical absorption index in a laminated structure with a wavelength conversion layer provided on the photoelectric conversion element.

A radiographic image-pickup device according to an embodiment of the present disclosure includes: a photoelectric conversion layer; a wavelength conversion layer provided on the photoelectric conversion layer and converting a wavelength of radiation into a wavelength within a sensitivity band of the photoelectric conversion layer; and a low-refractive-index layer provided between the photoelectric conversion layer and the wavelength conversion layer, and having a refractive index lower than a refractive index of each of the photoelectric conversion layer and the wavelength conversion layer.

On the radiographic image-pickup device according to the embodiment of the present disclosure, the low-refractive-index layer having the refractive index lower than the refractive index of each of the photoelectric conversion layer and the wavelength conversion layer is provided between the photoelectric conversion layer and the wavelength conversion layer. This gives rise to an optical interference easily until light is incident on the photoelectric conversion layer after it is emitted from the wavelength conversion layer. This ensures that an optical absorption index on the photoelectric conversion layer changes depending on a film thickness of the low-refractive-index layer to have a maximum value.

A radiographic image-pickup display system according to an embodiment of the present disclosure is provided with an image-pickup device obtaining a radiation-based image and a display unit displaying the image obtained by the image-pickup device. The image-pickup device includes: a photoelectric conversion layer; a wavelength conversion layer provided on the photoelectric conversion layer and converting a wavelength of radiation into a wavelength within a sensitivity band of the photoelectric conversion layer; and a low-refractive-index layer provided between the photoelectric conversion layer and the wavelength conversion layer, and having a refractive index lower than a refractive index of each of the photoelectric conversion layer and the wavelength conversion layer.

On the radiographic image-pickup device and the radiographic image-pickup display system according to the embodiments of the present disclosure, the low-refractive-index layer having the refractive index lower than the refractive index of each of the photoelectric conversion layer and the wavelength conversion layer is provided between the photoelectric conversion layer and the wavelength conversion layer, making it possible to have dependency on the film thickness of the low-refractive-index layer for the optical absorption index on the photoelectric conversion layer utilizing the optical interference effect. In other words, for example, it is possible to optimize the film thickness of the low-refractive-index layer to achieve a maximum value of the optical absorption index. Hence, it is possible to suppress the deterioration in the optical absorption index in a laminated structure with the wavelength conversion layer provided on the photoelectric conversion element.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the present disclosure, and are incorporated in and constitute a part of this specification. The drawings illustrate embodiments and, together with the specification, serve to explain the principles of the present technology.

FIG. 1 is a functional block diagram showing an overall configuration of a radiographic image-pickup device according to an embodiment of the present disclosure.

FIG. 2 is a pattern diagram showing a cross-sectional structure of the radiographic image-pickup device shown in FIG. 1.

FIG. 3 is an example for a pixel drive circuit (active drive circuit) on a unit pixel shown in FIG. 1.

FIG. 4 is a pattern diagram showing a cross-sectional structure of a transistor shown in FIG. 3.

FIG. 5 is a pattern diagram showing a cross-sectional structure of a photodiode shown in FIG. 3.

FIG. 6 is a pattern diagram showing a laminated structure in the vicinity of an interface between the photodiode shown in FIG. 4 and a scintillator layer shown in FIG. 2.

FIG. 7 is a cross-sectional pattern diagram for explanation of a relationship between a material example and refractive index on each layer in the laminated structure shown in FIG. 5.

FIG. 8 is a pattern diagram showing a laminated structure in the vicinity of an interface between a photodiode and a scintillator layer according to a comparative example.

FIG. 9 is a cross-sectional pattern diagram for explanation of a relationship between a material example and refractive index on each layer in the laminated structure shown in FIG. 8.

FIG. 10 is a diagram representing thickness and refractive index values of each layer to be used in comparative examples 1 and 2.

FIG. 11 is a characteristic diagram showing a relationship between a thickness and optical absorption index of a protective film SiN in the comparative example 1 (without scintillator layer, ITO: 80 nm), wherein (A) shows a case where an incident angle is 0 degree, and (B) shows a case where an incident angle is 30 degrees.

FIG. 12 is a characteristic diagram showing a relationship between a thickness and optical absorption index of a protective film SiN in the comparative example 2 (with scintillator layer, ITO: 80 nm), wherein (A) shows a case where an incident angle is 0 degree, and (B) shows a case where an incident angle is 30 degrees.

FIG. 13 is a diagram representing thickness and refractive index values of each layer to be used in Example 1.

FIG. 14 is a characteristic diagram showing a relationship between a thickness and optical absorption index of a low-refractive-index layer in the Example 1 (insertion of a low-refractive-index layer SiO₂, ITO: 80 nm), wherein (A) shows a case where an incident angle is 0 degree, and (B) shows a case where an incident angle is 30 degrees.

FIG. 15 is a characteristic diagram showing the dependency on an incident angle of the optical absorption index in the comparative example 1.

FIG. 16 is a characteristic diagram showing the dependency on an incident angle of the optical absorption index in the comparative example 2.

FIG. 17 is a characteristic diagram showing the dependency on an incident angle of the optical absorption index in the Example 1.

FIG. 18 is a pattern diagram showing a laminated structure in the vicinity of an interface between a photodiode and a scintillator layer according to modification 1.

FIG. 19 is a diagram representing thickness and refractive index values of each layer to be used in Example 2.

FIG. 20 is a characteristic diagram showing a relationship between a thickness and optical absorption index of a low-refractive-index layer in the Example 2 (insertion of a low-refractive-index layer SiO₂, ITO: 80 nm), wherein (A) shows a case where an incident angle is 0 degree, and (B) shows a case where an incident angle is 30 degrees.

FIG. 21 is a characteristic diagram depicting the dependency on an incident angle of the optical absorption index in the Example 2.

FIG. 22 is a pattern diagram showing a laminated structure in the vicinity of an interface between a photodiode and a scintillator layer according to modification 2.

FIG. 23 is a pattern diagram showing a laminated structure in the vicinity of an interface between a photodiode and a scintillator layer according to modification 3.

FIG. 24 is an example for a pixel drive circuit (passive drive circuit) according to modification 4.

FIG. 25 is a pattern diagram showing an overall configuration of a radiographic image-pickup display system according to an applicable example.

### DETAILED DESCRIPTION OF THE PREFERRED EMBODIMENTS

Hereinafter, embodiments of the present disclosure are described with reference to the drawings. It is to be noted that the descriptions are provided in order given below.
1. Embodiment (example of an indirect conversion type radiographic image-pickup device including a transparent conductive film, a protective layer, a low-refractive-index layer, and a wavelength conversion layer in order from a photoelectric conversion layer side)
2. Example 1 (simulation example equivalent to a configuration in the above item 1)
3. Modification 1 (example of a case where a low-refractive-index layer is provided between a transparent conductive film and a protective layer)
4. Example 2 (simulation example equivalent to a configuration in the above item 3)
5. Modification 2 (example of a case where an organic protective film is provided on a wavelength conversion layer)
6. Modification 3 (another arrangement example of an organic protective film)
7. Modification 4 (example of a case where a pixel drive circuit is configured as a passive drive circuit)
8. Applicable example (example of a radiographic image-pickup display system)

### Embodiment

### Overall Configuration of Radiographic Image-Pickup Device

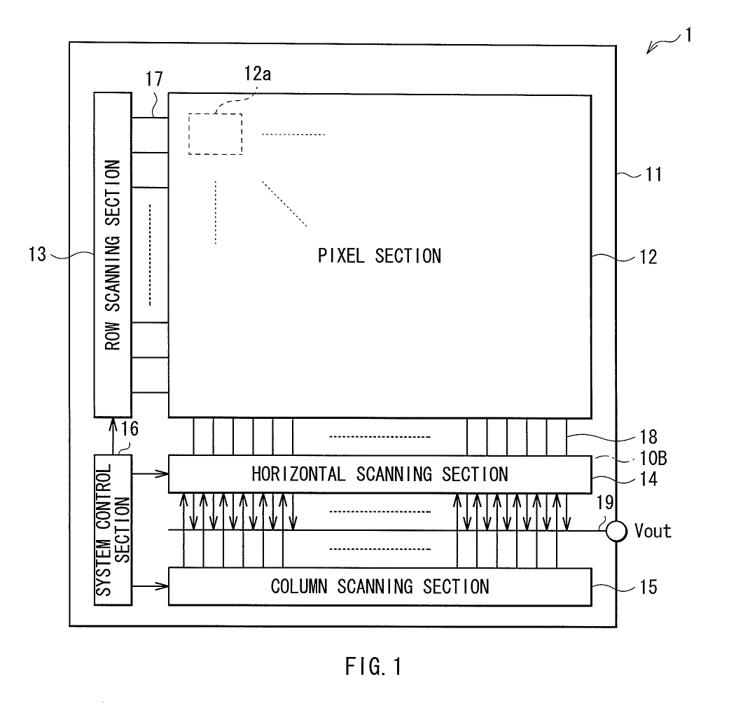

FIG. 1 shows an overall configuration of a radiographic image-pickup device (radiographic image-pickup device 1) according to an embodiment of the present disclosure. The radiographic image-pickup device 1, which is so-called an indirect conversion type FPD (Flat Panel Detector), receives radiation rays typically including alpha ray, beta ray, gamma ray, and X-ray in a form of light after their wavelength conversion, and then reads image information based on the radiation rays. The radiographic image-pickup device 1 is preferably used as an X-ray image-pickup device for a medical application as well as for other nondestructive inspection applications such as baggage inspection.

The radiographic image-pickup device 1 has a pixel section 12 on a substrate 11 with a peripheral circuit (drive circuit) including, for example, a row scanning section 13, a horizontal selecting section 14, a column scanning section 15, and a system control section 16 provided around the pixel section 12.

The pixel section 12 is served as an image-pickup area on the radiographic image-pickup device 1. The pixel section 12 has unit pixels 12a (hereinafter referred to as simply a “pixel” in some cases) that are disposed in a two-dimensional arrangement with a matrix pattern, each of which includes a photoelectric converter element (photodiode 111A as described later) to generate and store internally an optical charge of an amount corresponding to an amount of incident light. On the unit pixel 12a, for example, two wires (in particular, a row selection line and a reset control line) are provided for each pixel row as pixel drive lines 17.

Further, on the pixel section 12, the pixel drive lines 17 are wired along the row direction (pixel array direction along pixel row) for each pixel row, while vertical signal lines 18 are wired along the column direction (pixel array direction along pixel column) for each pixel column for a pixel array in a matrix pattern. The pixel drive lines 17 transmit drive signals for reading signals from pixels. In FIG. 1, the pixel drive lines 17 are shown with a single wire, but are not limited to a single line. One end of each of the pixel drive lines 17 is connected with an output terminal corresponding to each row on the row scanning section 13. A configuration of the pixel section 12 is described later.

The row scanning section 13, which includes a shift register, an address decoder, and the like, is a pixel drive section to drive each pixel 12a on the pixel section 12 in a row unit for example. The output signal from each unit pixel on a pixel row that is selected and scanned by the row scanning section 13 is provided to the horizontal selecting section 14 through each of the vertical signal lines 18. The horizontal selecting section 14 includes an amplifier, a horizontal selection switch, and the like that are provided for each vertical signal line 18.

The column scanning section 15, which includes a shift register, an address decoder, and the like, scans and sequentially drives each horizontal selection switch on the horizontal selecting section 14. Through the selective scanning performed by the column scanning section 15, each pixel signal transmitted via each of the vertical signal lines 18 is sequentially output to horizontal signal lines 19, through which being transmitted to the outside of the substrate 11.

A circuit section including the row scanning section 13, the horizontal selecting section 14, the column scanning section 15, and the horizontal signal lines 19 may be a circuit formed directly on the substrate 11, or may be a circuit provided on an external control IC. Alternatively, such a circuit section may be formed on another substrate connected by a cable and the like.

The system control section 16 receives a clock to be supplied from the outside of the substrate 11, data for instructing an operation mode, or the like, and outputs data such as internal information of the radiographic image-pickup device 1. Further, the system control section 16 has a timing generator to generate various timing signals, performing a drive control of a peripheral circuit including the row scanning section 13, the horizontal selecting section 14, and the column scanning section 15 on the basis of various timing signals generated by the timing generator.

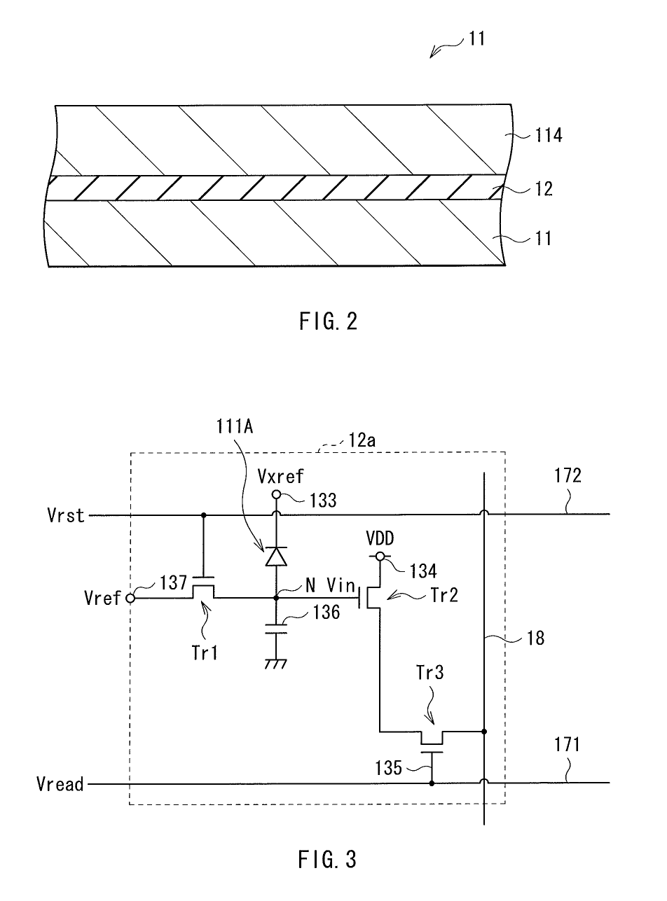

FIG. 2 shows a cross-sectional structure of the radiographic image-pickup device 1 in a pattern view. As shown in the figure, an indirect conversion type FPD has a scintillator layer 114 (wavelength conversion layer) further on the pixel section 12. The pixel section 12 has a photodiode 111A and transistors 111B (Tr1, Tr2, and Tr3) as described later for each pixel, wherein light emitted from the scintillator layer 114 (light for which wavelength conversion is completed) is received by the photodiode 111A, and the received light is read out as an electrical signal by the reading transistor (Tr3). In the vicinity of an interface between the pixel section 12 and the scintillator layer 114, a protective layer 128 and a low-refractive-index layer 129 are laminated as described in details later.

The scintillator layer 114 converts a radiation wavelength into a wavelength within a sensitivity band of the photodiode 111A. As a material example, a phosphor for converting an X-ray into visible light may be used for the scintillator layer 114. Such phosphor examples include cesium iodide (CsI) with additive thallium (Tl), cadmium sulfuric oxide (Gd₂O₂S) with additive terbium (Tb), BaFX (X is Cl, Br, I, etc.), and the like. It is preferable that thickness of the scintillator layer 114 be in a range from 100 to 600 μm, and, for example, 600 μm is applicable. Such a scintillator layer 114 may be deposited on a planarized film 113 using, for example, a vacuum deposition method. Hereinafter, detailed configuration of the pixel section 12 is described.

### [Detailed Configuration of Pixel Section 12]

### (Pixel Circuit)

FIG. 3 is an example for a circuit configuration (active drive circuit) of the unit pixel 12a on the pixel section 12. The unit pixel 12a includes, for example, the photodiode 111A, the transistors Tr1, Tr2, and Tr3 (equivalent to the transistor 111B as described later), the vertical signal line 18, a row selection line 171 and a reset control line 172 that are both served as the pixel drive line 17.

The photodiode 111A is, for example, a PIN (Positive Intrinsic Negative Diode) photodiode with its sensitivity band (received light wavelength band) within a visible range (visible light is receivable). The photodiode 111A generates a signal charge of the amount corresponding to the amount of incident light (received light amount) with a reference potential Vxref applied to an upper electrode 126 (terminal 133) for example. On the photodiode 111A, for example, a lower electrode side (p-type semiconductor layer 122) is connected with a storage node N. A capacitance component 136 is present on the storage node N, where a signal charge generated by the photodiode 111A is stored. It is to be noted that a pixel circuit may be configured to connect the photodiode 111A between the storage node N and a ground (GND). A cross-sectional structure of this photodiode is described later.

All of the transistors Tr1, Tr2, and Tr3 are, for example, N-channel type field-effect transistors each having a channel-forming semiconductor layer (semiconductor layer 126 as described later) including a silicon-based semiconductor such as a noncrystalline silicon, a microcrystalline silicon, and a polycrystalline silicon, preferably a low-temperature polycrystalline silicon. Alternatively, the semiconductor layer may be formed of an oxide semiconductor such as indium gallium zinc oxide (InGaZnO) and zinc oxide (ZnO).

The transistor Tr1, which is a reset transistor, is connected between a terminal 137 to which a reference potential Vref is applied and the storage node N. The transistor Tr1 resets a potential on the storage node N to the reference potential Vref by turning on in response to a reset signal Vrst. The transistor Tr2 is a reading transistor with its gate and terminal 134 (drain) connected to the storage node N and a supply voltage VDD, respectively. The transistor Tr2 receives on the gate a signal charge generated by the photodiode 111A, and outputs a signal voltage according to the received signal charge. The transistor Tr3, which is a row selection transistor, is connected between a source on the transistor Tr2 and the vertical signal line 18, and outputs a signal from the transistor Tr2 to the vertical signal line 18 by turning on in response to a row scanning signal Vread. Alternatively, for the transistor Tr3, a configuration to connect the transistor Tr3 between a drain on the transistor Tr2 and the supply voltage VDD may be employed. Hereinafter, a cross-sectional structure of those transistors (collectively called the transistor 111B) is described.

### (Cross-Sectional Structure of Transistor 111B)

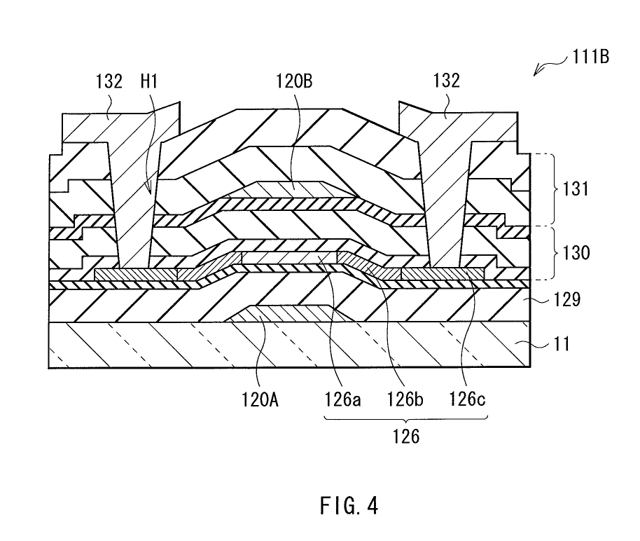

FIG. 4 shows an example for a cross-sectional structure of the transistor 111B, equivalent to a part of a cross-sectional structure on the pixel section 12. The transistor 111B has so-called a dual gate structure where two gate electrodes are provided with the semiconductor layer 126 interposed between. For example, the transistor 111B has, on the substrate 11, a first gate electrode 120A, and a first gate insulating film 129 formed to cover the first gate electrode 120A. On the first gate insulating film 129, the semiconductor layer 126 including a channel layer 126a is provided. A second gate insulating film 130 is formed to cover the semiconductor layer 126, and a second gate electrode 120B is provided on a region in opposition to the first gate electrode 120A on the second gate insulating film 130. On the second gate electrode 120B, an interlayer insulating film 131 is formed, and a source-drain electrode 132 is provided to fill in a contact hole H1 formed between the interlayer insulating film 131 and the second gate insulating film 130.

Each of the first gate electrode 120A and the second gate electrode 120B is formed of a single-layer film or a multilayer laminated film including any material of titanium (Ti), aluminum (Al), molybdenum (Mo), tungsten (W), or chrome (Cr), for example. The thickness of each of the first gate electrode 120A and the second gate electrode 120B is in a range from 30 nm to 150 nm.

Each of the first gate insulating film 129 and the second gate insulating film 130 is a single-layer film such as oxide silicon (SiO₂), oxide silicon nitride (SiON), and silicon nitride (SiNx), or a laminated film stacking a plurality of layers formed of such a silicon compound, for example.

The semiconductor layer 126 is formed of, for example, a noncrystalline silicon, a polycrystalline silicon, a low-temperature polycrystalline silicon, or a microcrystalline silicon, preferably the low-temperature polycrystalline silicon. Alternatively, the semiconductor layer 126 may be formed of an oxide semiconductor such as indium gallium zinc oxide (IGZO). On the semiconductor layer 126, an LDD layer 126b is formed between the channel layer 126a and an N⁺ layer 126c to reduce a leakage current. The source-drain electrode 132, which is formed of a single-layer film or a multilayer laminated film including any material of Ti, Al, Mo, W, or Cr, for example, is connected with a wire for signal readout.

The interlayer insulating film 131 is formed of a single-layer film such as oxide silicon, oxide silicon nitride, and silicon nitride, or a laminated film stacking a plurality of layers formed of such a silicon compound.

It is to be noted that the transistor 111B is not limited to the above-mentioned type having a dual gate structure, but may be any transistor employing an arrangement wherein one gate electrode is provided in opposition to a channel on the semiconductor layer.

### (Cross-Sectional Structure of Photodiode 111A)

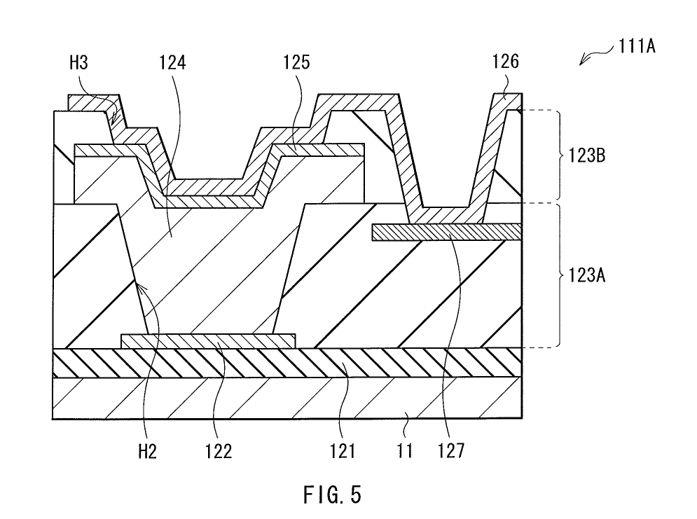

FIG. 5 shows an example for a cross-sectional structure of the photodiode 111A, equivalent to a part of the pixel section 12. The photodiode 111A is provided together with the transistor 111B on the substrate 11, and, for example, a part of laminated structure thereof is common with the transistor 111B, being formed using the same thin-film process. Hereinafter, detailed structure of the photodiode 111A is described.

The photodiode 111A has a p-type semiconductor layer 122 via a gate insulating film 121 at a selective region on the substrate 11. On the substrate 11 (specifically, on the gate insulating film 121), an interlayer insulating film 123A having a contact hole H2 is provided in opposition to the p-type semiconductor layer 122. On the p-type semiconductor layer 122 within the contact hole H2 of the interlayer insulating film 123A, an i-type semiconductor layer 124 is provided, and an n-type semiconductor layer 125 is formed on the i-type semiconductor layer 124. On the n-type semiconductor layer 125, an interlayer insulating film 123B having a contact hole H3 is provided, and the n-type semiconductor layer 125 is connected with an upper electrode 126 (conductive film) via the contact hole H3.

It is to be noted that an example where the p-type semiconductor layer 122 is provided at the substrate 11 side (lower side), while the n-type semiconductor layer 125 is provided at the upper side is cited here, but a structure opposite of this, that is, a structure with the n-type at the lower side (substrate 11 side) and the p-type at the upper side may be employed. Further, the gate insulating film 121, the interlayer insulating film 123A, and the interlayer insulating film 123B have partially or wholly the same layered structure as each layer of the first gate insulating film 129, the second gate insulating film 130, and the interlayer insulating film 131 on the transistor 111B. The photodiode 111A may be formed using the same thin-film process as with the transistor 111B.

The p-type semiconductor layer 122, which is a p+ region including, for example, a polycrystalline silicon (polysilicon) doped with p-type impurities such as boron (B), has a thickness in a range from 40 nm to 50 nm for example. The p-type semiconductor layer 122 is also served as a lower electrode for reading a signal charge for example, and is connected with the storage node N (FIG. 3) as an example (alternatively, the p-type semiconductor layer 122 is served as the storage node N to store a charge).

The i-type semiconductor layer 124, which is a semiconductor layer exhibiting the intermediate conductivity between p-type and n-type such as a non-doped intrinsic semiconductor layer, is formed of, for example, a noncrystalline silicon (amorphous silicon: α-Si). The i-type semiconductor layer 124 has a thickness in a range from 400 nm to 1000 nm for example, and increased thickness assures higher optical sensitivity.

The n-type semiconductor layer 125, which is made of, for example, a noncrystalline silicon, forms the n+ region. The n-type semiconductor layer 125 has a thickness in a range from 10 nm to 50 nm for example.

The upper electrode 126, which is an electrode for providing a reference potential for photoelectric conversion, is formed of a transparent conductive film such as ITO (Indium Tin Oxide). The upper electrode 126 is connected with a power supply wire 127 for providing a supply voltage to the upper electrode 126. The thickness of the upper electrode 126 is in a range from 50 nm to 100 nm for example, and is preferably set up to satisfy a conditional equation as described later (conditional equation (3)). The power supply wire 127 is made of a material with a resistance lower than the upper electrode 126, such as Ti, Al, Mo, W, and Cr.

[Laminated Structure in the Vicinity of Interface between Photodiode and Scintillator Layer]

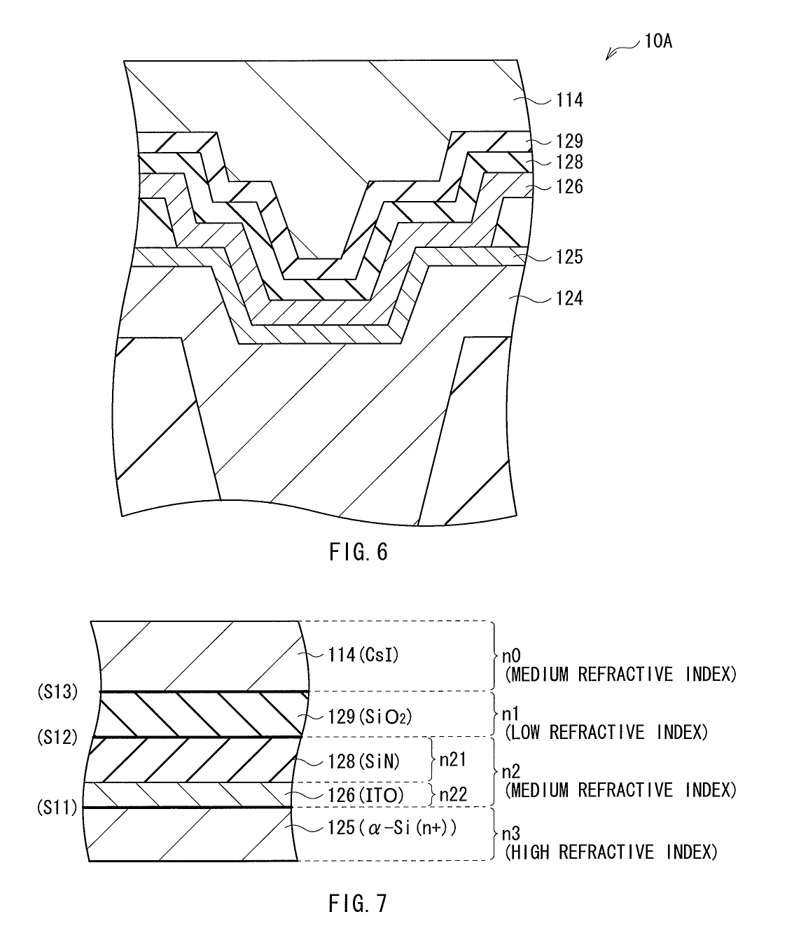

FIG. 6 shows a laminated structure (laminated structure 10A) in the vicinity of an interface between the photodiode 111A and the scintillator layer 114 in a pattern view. In the radiographic image-pickup device 1, the scintillator layer 114 is provided on the pixel section 12 as described previously. According to the present embodiment, however, a protective layer 128 and a low-refractive-index layer 129 are further provided in order from the photodiode 111A side (upper electrode 126 side) in the vicinity of an interface between the photodiode 111A and the scintillator layer 114.

The protective layer 128, which is a passivation film for protecting the photodiode 111A, is formed of, for example, a silicon nitride (SiN). The thickness of the protective layer 128 is in a range from 130 nm to 180 nm for example, and is preferably set up to satisfy a conditional equation as described later (conditional equation (3)).

The low-refractive-index layer 129 is formed of a material exhibiting relatively low refractive index in the vicinity of the interface, for example, a material with the refractive index lower than that of the n-type semiconductor layer 125 served as a photoelectric conversion layer (or i-type semiconductor layer 124), the upper electrode 126, a protective layer 127, and the scintillator layer 114. The thickness of the low-refractive-index layer 129 is in a range from 80 nm to 100 nm for example, and is preferably set up to satisfy a conditional equation as described later (conditional equation (2)). Constituent materials for the low-refractive-index layer 129 may include materials exhibiting the refractive index lower than that of other layers composing the laminated structure 10A, such as SiO₂ and SiON. It is to be noted that an insulating material such as SiO₂ is used as a material for the low-refractive-index layer 129 here, but a material is not limited to such an insulating material, and any material exhibiting the conductivity may be used alternatively. When a conductive film with low refractive index is used, this is also served as the upper electrode 126, resulting in a structure wherein the low-refractive-index layer 129, the protective layer 128, and the scintillator layer 114 are laminated in order from the n-type semiconductor layer 125 side.

### (Condition for Refractive Index and Film Thickness)

According to the present embodiment, in the laminated structure 10A as described above, the refractive index values of the low-refractive-index layer 129 and any other layers satisfy the conditional equation (1) given below. In the equation, the refractive index of a layer provided on or above the low-refractive-index layer 129 is n0, the refractive index of the low-refractive-index layer 129 is n1, the refractive index of a layer provided between the low-refractive-index layer 129 and the n-type semiconductor layer 125 is n2, and the refractive index of the n-type semiconductor layer 125 is n3.

n0>n1<n2<n3 (1)

Here, the laminated structure 10A is a structure wherein the upper electrode 126, the protective layer 128, the low-refractive-index layer 129, and the scintillator layer 114 are provided in order from the n-type semiconductor layer 125 side, and thus the refractive index of the scintillator layer 114 is n0, the refractive index of the low-refractive-index layer 129 is n1, the refractive index of the protective layer 128 and the upper electrode 126 is n2 (specifically, n21 or n22), and the refractive index of the n-type semiconductor layer 125 is n3. For the protective layer 128 and the upper electrode 126, it is to be noted that the refractive index n2 may satisfy the conditional equation (1) for each of the refractive index values n21 and n22.

FIG. 7 shows a material example on each layer in the laminated structure 10A satisfying a relationship of the refractive index as described above, as well as a relative degree (low, medium, high) of the refractive index. As shown in the figure, the n-type semiconductor layer 125 (α−Si (n+)) exhibits high refractive index (n3=4), while the scintillator layer 114 (CsI), the protective layer 128 (SiN), and the upper electrode 126 (ITO) exhibit almost the same medium refractive index (n0=1.77, n21=1.82, and n22=1.73). In this embodiment of the present disclosure, a structure is employed wherein the low-refractive-index layer 129 (SiO₂) exhibiting lower refractive index (n1=1.43) is interposed between such medium refractive index layers (between the protective layer 128 and the scintillator layer 114 in this case). In such a structure, especially when values of n0 and n2 (n21 or n22) are close relatively, advantageous effect of providing the low-refractive-index layer 129 is increased.

More specifically, provision of the low-refractive-index layer 129 assures an advantageous effect as described hereinafter in a relative magnitude relation of at least the refractive index values n0, n1, n21, n22, and n3. It is to be noted that the refractive index of an air layer is 1.0, and “low”, “medium”, and “high” denoted in parentheses indicate relative degrees of the refractive index, respectively.

First, the laminated structure 10A as described above that has no CsI layer results in a structure wherein the air layer (low), the SiN layer and ITO layer (medium), and the α-Si layer (high) are laminated in order from the light incidence side. Such a structure gives rise to an optical interference effect, enhancing the absorption index of light incident from the air.

However, the laminated structure 10A that has the CsI layer results in a structure wherein the air layer (low), the CsI layer (medium), the SiN layer and ITO layer (medium), and the α-Si layer (high) are laminated in order from the light incidence side. In such a structure, the CsI layer and the SiN layer (or the ITO layer) have almost equivalent refractive index (the SiN layer, the ITO layer and the like make no contribution to the optical interference effect), which makes it difficult to obtain the advantageous effect of enhancement of the optical absorption index.

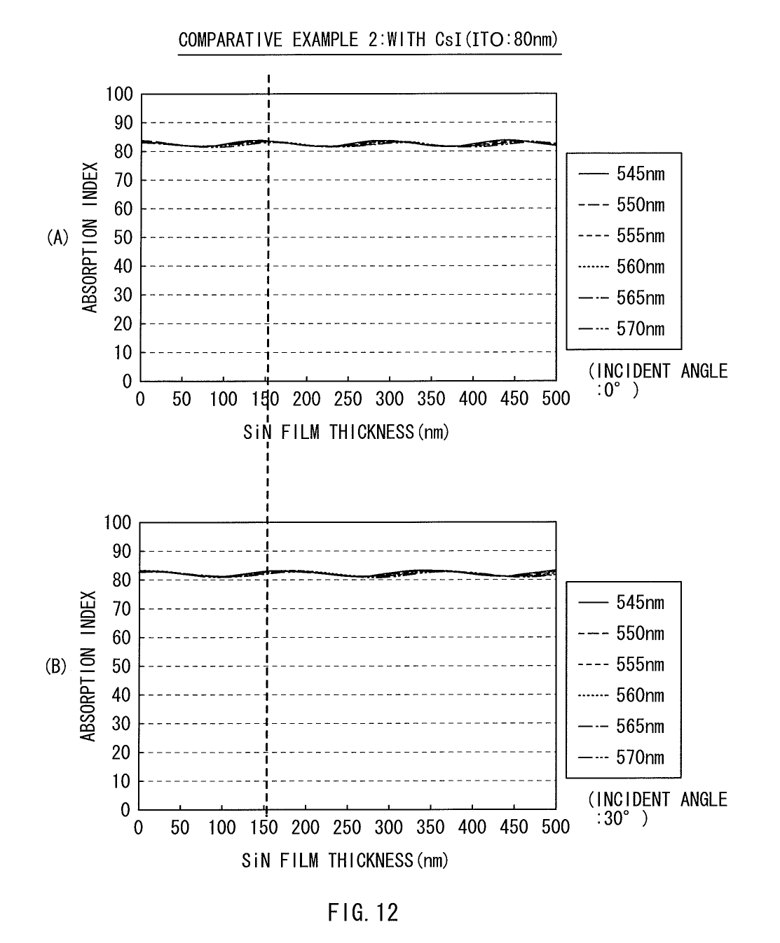

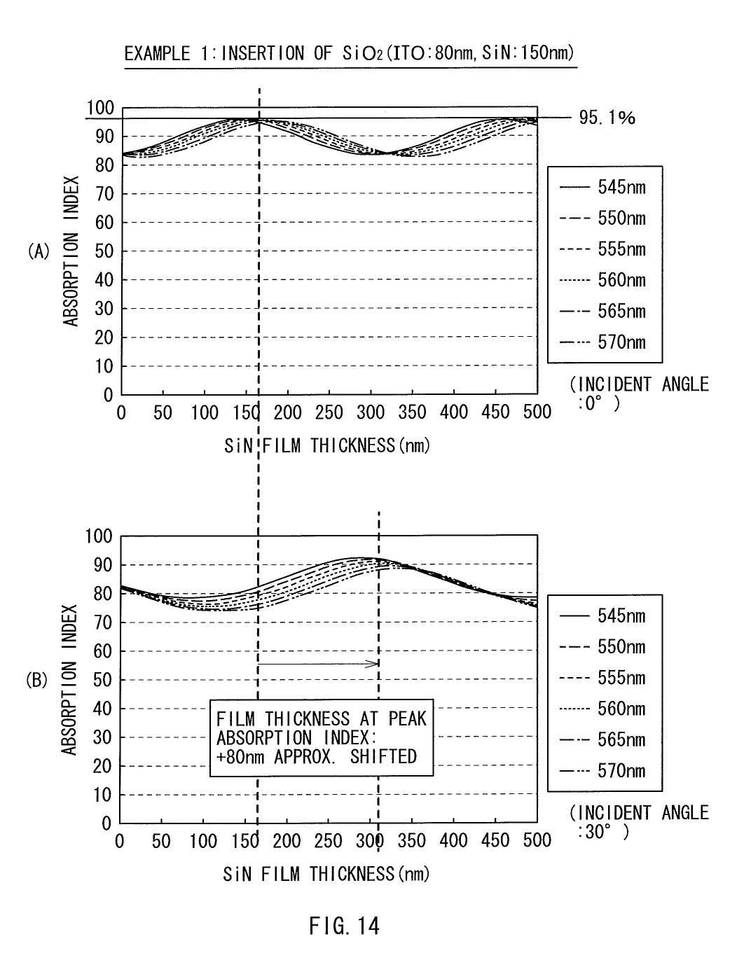

Therefore, if only the SiO₂ layer (low) is provided on any layer between the CsI layer (medium) and the α-Si layer (high), this makes it possible to obtain the advantageous effect of enhancement of the optical absorption index (or suppression of deterioration in the optical absorption index) by virtue of the optical interference effect. This can be seen from FIG. 12 and FIG. 14 as described later. Further, to obtain the advantageous effect of enhancement of the optical absorption index more efficiently, it is presumably desirable to set up a relationship between the refractive index and film thickness on each layer as described below.

More specifically, when the conditional equation (1) is satisfied in the laminated structure 10A, it is presumably desirable that the refractive index (n1) and thickness (d1) of the low-refractive-index layer 129 further satisfy the conditional equation (2) given below. In the conditional equation (2), m is an integer, and λ is a wavelength of incident light. As indicated in the Example to be hereinafter described, setup of a film thickness to satisfy the conditional equation (2) assures an efficient use of the optical interference effect. That is, due to the optical interference, the optical absorption index on a photoelectric conversion layer changes (forms a minimum point and a maximum point) depending on a film thickness of the low-refractive-index layer 129. This allows a film thickness of the low-refractive-index layer 129 to be optimized so that the optical absorption index may take a maximum point (maximum value), thereby suppressing the deterioration in the optical absorption index.

n1×d1=(2m+1)×(λ/4) (2)

Further, it is presumably more desirable to satisfy the conditional equation (3) given below in addition to the conditional equations (1) and (2). In the conditional equation (3), m′ is an integer, a thickness of the protective layer 128 is d21, and a thickness of the upper electrode 126 is d22. Hence, in the present embodiment, it is more preferable to optimize film thickness values of two medium-refractive-index layers of the protective layer 128 and the upper electrode 126 that are provided between the n-type semiconductor layer 125 and the low-refractive-index layer 129.

(n21×d21)+(n22×d22)=(2m′+1)×(λ/4) (3)

### [Operation and Advantageous Effects]

An operation and advantageous effects according to the present embodiment are described with reference to FIG. 1 to FIG. 9. The radiographic image-pickup device 1 acquires radiation being irradiated from a radiation (for example, X-ray) irradiation source that is not shown in the figure and transmitting through a radiographic subject (detecting object), and carries out wavelength conversion followed by photoelectric conversion of the acquired radiation, thereby obtaining an image of the radiographic subject as an electrical signal. More specifically, the radiation incoming into the radiographic image-pickup device 1 is first converted into a wavelength within a sensitivity band (visible range in this case) of the photodiode 111A on the scintillator layer 114. When the light (visible light) after wavelength conversion is emitted from the scintillator layer 114, this visible light is incident on the pixel section 12.

On the pixel section 12, when a predetermined voltage is applied to the photodiode 111A via the upper electrode 126 from a power supply wire that is not shown in the figure, the visible light incident from the upper electrode 126 side is converted into a signal charge of the amount corresponding to the amount of received light (photoelectric conversion is carried out). A signal charge generated by the photoelectric conversion is taken out as an optical current from the p-type semiconductor layer 122 side.

More specifically, any charge generated by photoelectric conversion on the photodiode 111A is collected by a storage layer (p-type semiconductor layer 122, storage node N), and read out as a current from this storage layer, being delivered to a gate on the transistor Tr2 (reading transistor). The transistor Tr2 outputs a signal voltage corresponding to the relevant signal charge. When the transistor Tr3 turns on in response to the row scanning signal Vread, the output signal from the transistor Tr2 is output (read out) on the vertical signal line 18. The signal that is read out in such a manner is output to the horizontal selecting section 14 for each pixel row via the vertical signal line 18.

### Comparative Example

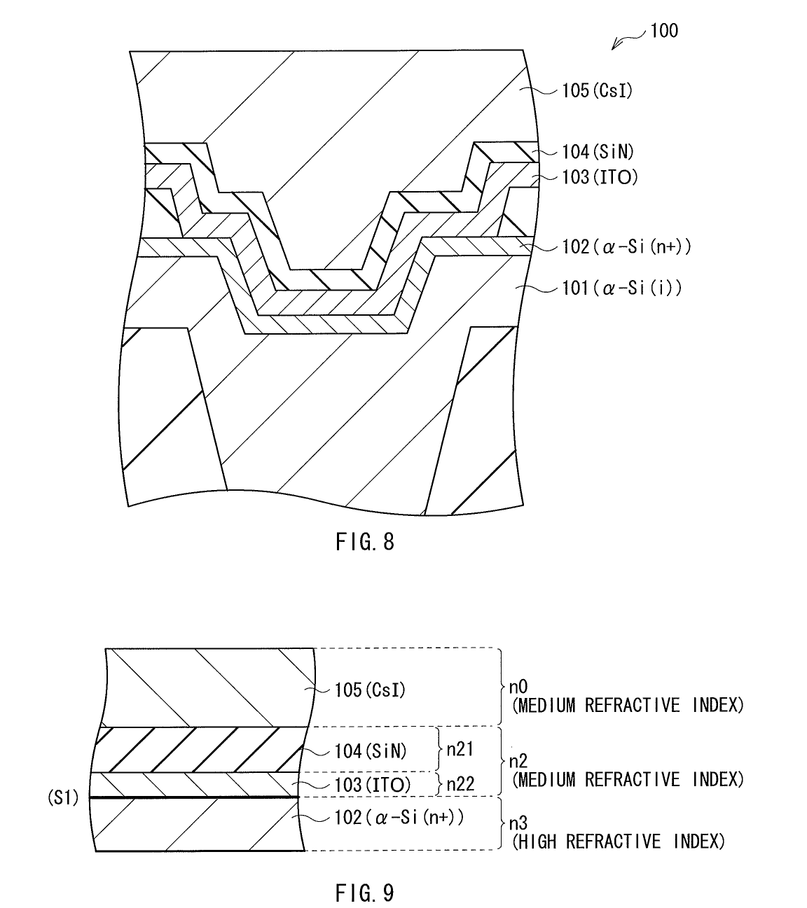

FIG. 8 shows a laminated structure (laminated structure 100) in the vicinity of an interface between a photodiode and a scintillator layer on a radiographic image-pickup device according to a comparative example for the embodiment. FIG. 9 shows a material example and relative degrees of the refractive index thereof (medium, high) on each layer in the laminated structure 100. In such a laminated structure 100, an upper electrode 103 (ITO), a protective layer 104 (SiN), and a scintillator layer 105 (CsI) are provided in this order on a photoelectric conversion layer (i-type semiconductor layer 101 and n-type semiconductor layer 102) that is formed of an α-Si material. In other words, all of the upper electrode 103, the protective layer 104, and the scintillator layer 105 that are provided on the n-type semiconductor layer 102 with high refractive index (n3) exhibit almost equivalent medium refractive indexes (n22, n21, and n0).

In such a laminated structure 100, for example, radiation incoming into the scintillator layer 105 at an incident angle of zero degree (vertical incidence) is emitted out toward the n-type semiconductor layer 102 side after wavelength conversion into visible light. At this time, because the scintillator layer 105, the protective layer 104, and the upper electrode 103 exhibit almost equivalent refractive indexes in the comparative example, the visible light is almost vertically transmitted through the protective layer 104 and the upper electrode 103 in this order after being emitted out of the scintillator layer 105. Since the n-type semiconductor layer 102 has high refractive index, however, the visible light is reflected at an interface (S1) between the upper electrode 103 and the n-type semiconductor layer 102, which gives rise to a light loss easily. For an indirect conversion type radiographic image-pickup device with a scintillator layer, such a light loss may deteriorate the optical absorption index on a photoelectric conversion layer. This takes place similarly when the scintillator layer 105 is placed directly on the top surface of the upper electrode 103 without providing the protective layer 104.

It is to be noted that when no scintillator layer is provided on the photodiode, that is, for a commonly-used image-pickup device such as CCD and CMOS that has an air layer directly above the photodiode, the optical interference effect is generated as described previously, resulting in a light loss as stated above being prevented. An issue concerning deterioration of the optical absorption index as stated above may arise inherently in an indirect conversion type radiographic image-pickup device with a scintillator layer.

According to the present embodiment of the present disclosure, therefore, as shown in FIG. 6 and FIG. 7, the low-refractive-index layer 129 is provided between the photodiode 111A and the scintillator layer 114, in concrete terms, between the scintillator layer 114 and the protective layer 128 each having medium refractive index. In other words, a laminated structure 10A has the low-refractive-index layer 129 to satisfy the conditional equation (1). As a result, even if visible light emitted from the scintillator layer 114 is reflected at an interface S11 between the n-type semiconductor layer 125 and the upper electrode 126, the visible light is reflected at an interface (S12) between the protective layer 128 and the low-refractive-index layer 129, and at an interface (S13) between the low-refractive-index layer 129 and the scintillator layer 114. Repeated light reflection generates an optical interference. Provision of the low-refractive-index layer 129 between the scintillator layer 114 and the n-type semiconductor layer 125 in such a method gives rise to an optical interference effect. It is to be noted that the low-refractive-index layer 129 is provided between the scintillator layer 114 and the protective layer 128 in this example, but an arrangement of the low-refractive-index layer 129 is not limited to such a location, and the low-refractive-index layer 129 may be placed at any position between the scintillator layer 114 and the n-type semiconductor layer 125. If only the low-refractive-index layer 129 is provided on any layer between the scintillator layer 114 and the n-type semiconductor layer 125, an optical interference effect similar to that described above is assured.

Due to such an optical interference effect, the optical absorption index on a photoelectric conversion layer changes (forms a minimum point and a maximum point). A change in the optical absorption index arises primarily depending on a film thickness of the low-refractive-index layer 129. It is presumable that this allows a film thickness of the low-refractive-index layer 129 to be optimized so that the optical absorption index may take a maximum point (maximum value), thereby more efficiently suppressing the deterioration in the optical absorption index.

Specifically, it is presumed that a film thickness of the low-refractive-index layer 129 may satisfy the conditional equation (2). Thereby, as indicated in the Example as described later, it is possible to optimize a film thickness of the low-refractive-index layer 129 so that the optical absorption index of visible light based on radiation incoming at an incident angle of 0 degree may become a maximum value. Further, at this time, it is more preferable that each film thickness of the upper electrode 126 and the protective layer 128 satisfy the conditional equation (3). More specifically, it is preferable to optimize an optical path length determined by film thickness and refractive index values of the upper electrode 126 and the protective layer 128 as well as an optical path length determined by film thickness and refractive index values of the low-refractive-index layer 129 (to minimize the reflectance, in other words, maximize the transmittance).

Further, as detailed later, the optical absorption index of a photoelectric conversion layer has dependence on an incident angle (incident angle of radiation incoming into the scintillator layer 114) as well. An arrangement of the laminated structure 10A including the above-mentioned low-refractive-index layer 129 makes it possible to selectively increase the optical absorption index especially in the direction at an incident angle of zero degree (vertical direction), (and to selectively prevent radiation incoming from an oblique direction from being received). This allows an image without an inter-pixel leakage (crosstalk) to be obtained.

As described above, according to this embodiment, in the laminated structure 10A between the photodiode 111A and the scintillator layer 114, the low-refractive-index layer 129 with the refractive index lower than that of each of the scintillator layer 114, the protective layer 128, the upper electrode 126, and the n-type semiconductor layer 125 is provided between the scintillator layer 114 and the n-type semiconductor layer 125. Such an arrangement ensures to suppress deterioration in the optical absorption index on a photoelectric conversion layer utilizing the optical interference effect. In other words, in a structure with the scintillator layer 114 provided on the photodiode 111A, it is possible to suppress the deterioration in the optical absorption index.

### Example

Next, a numerical example (simulation) for the radiographic image-pickup device 1 according to the above embodiment of the present disclosure is described.

### Comparative Examples 1 and 2

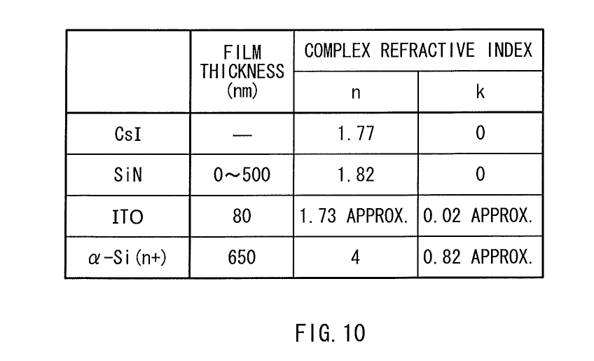

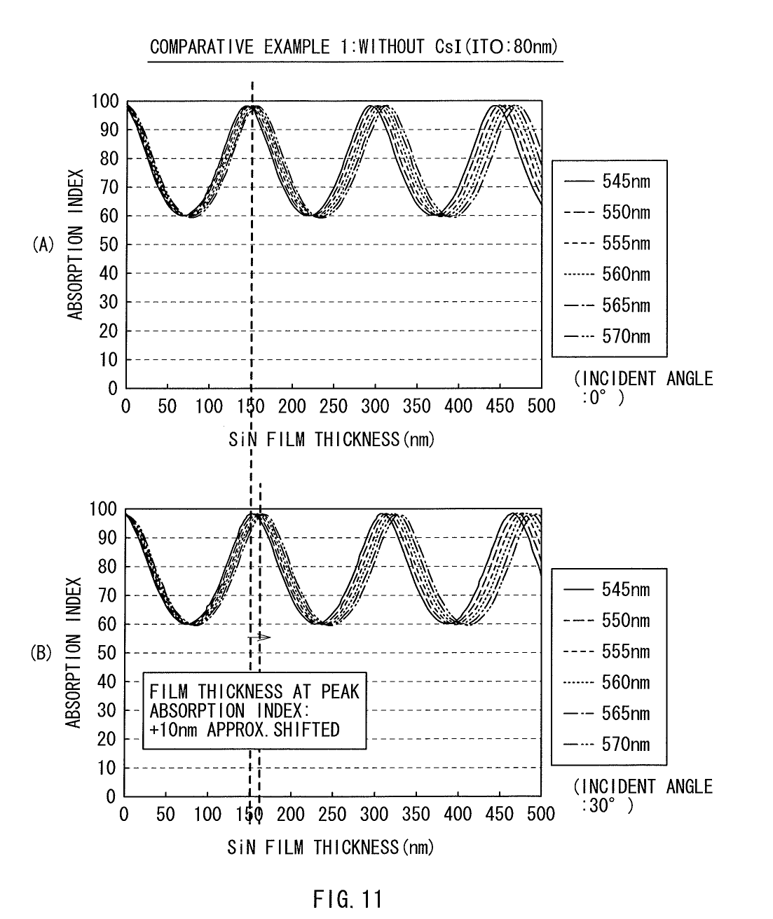

First, for the laminated structure 100 (FIGS. 8 and 9) in the above-mentioned comparative example, the optical absorption index was measured under conditions as described below. That is, as comparative example 1, for a structure without the scintillator layer 105 provided thereon (structure with an air layer on the protective layer 104), the optical absorption index was measured with radiation incoming at incident angles of 0 and 30 degrees respectively. Further, as comparative example 2, for a structure with the scintillator layer 105 provided thereon, the optical absorption index was measured with radiation incoming at incident angles of 0 and 30 degrees respectively. FIG. 10 summarizes the conditions for film thickness and refractive index on each layer of the laminated structure 100 used in these comparative examples 1 and 2. It is to be noted that, in either case, a film thickness of the protective layer 104 was changed in a range from zero nm to 500 nm, and a film thickness of the ITO was 80 nm. Further, a visible light wavelength was within a range from 545 nm to 570 nm (incremental in 5 nm step). Those results are shown in (A) and (B) of FIG. 11 as well as in (A) and (B) of FIG. 12. It is to be noted that, for the optical absorption index, a ratio (so-called an external quantum efficiency) of the number of absorbed photons to the number of incident photons on the semiconductor layers (101 and 102) is shown.

As shown in (A) and (B) of FIG. 11, in the comparative example 1 where the scintillator layer 105 is not provided, the optical absorption index forms a maximum point (peak) depending on a film thickness of the protective layer 104 (SiN) due to the optical interference effect, and thus optimal setup of a film thickness of the SiN prevents the optical absorption index from being deteriorated. However, even though the incident angle is changed from zero to 30 degrees, a change in the film thickness of the SiN that assures the maximum value of the optical absorption index is only in the order of about 10 nm, which means low dependency on the incident angle. As detailed later, such low dependency on the incident angle may easily give rise to the inter-pixel crosstalk.

On the other hand, as shown in (A) and (B) of FIG. 12, in the comparative example 2 where the scintillator layer 105 is provided, it is difficult for the optical absorption index to form a maximum point depending on the film thickness of the protective layer 104 (SiN) due to absence of the optical interference, resulting in the optical absorption index being reduced down to 82% approximately. Further, as with the above-mentioned comparative example 1, even though the incident angle is changed from zero to 30 degrees, a change in the film thickness of the SiN that assures the maximum value of the optical absorption index is only in the order of about 10 nm, which means low dependency on the incident angle. As detailed later, such low dependency on the incident angle may easily give rise to the inter-pixel crosstalk.

### Example 1

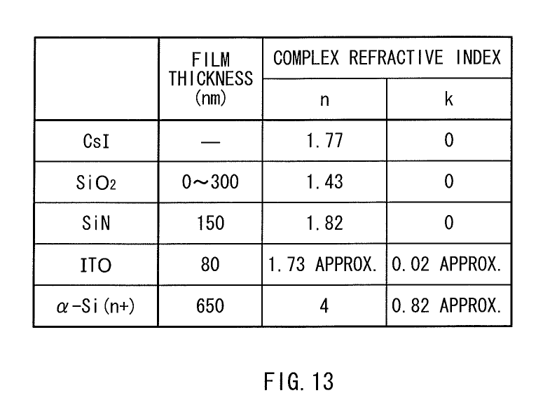

As an Example 1 with respect to the comparative example 1, for the laminated structure 10A according to the above embodiment of the present disclosure as well, the optical absorption index was measured with radiation incoming at incident angles of 0 and 30 degrees respectively. FIG. 13 summarizes the conditions for film thickness and refractive index on each layer of the laminated structure 10A used in the Example 1. It is to be noted that, in the Example 1, a film thickness of the low-refractive-index layer 129 (SiO₂) was changed in a range from zero nm to 300 nm, and film thickness values of the ITO and the protective layer 128 (SiN) were 80 nm and 150 nm, respectively. Further, a visible light wavelength was within a range from 545 to 570 nm (incremental in 5 nm step) as with the above-mentioned comparative example. Those results are shown in (A) and (B) of FIG. 14.

As shown in (A) and (B) of FIG. 14, in the Example 1 where the low-refractive-index layer 129 (SiO₂) is provided between the protective layer 128 and the scintillator layer 114, it is seen that the optical absorption index forms a maximum point depending on the SiO₂ film thickness by virtue of the optical interference effect. In other words, it can be seen that optimization of the SiO₂ film thickness is allowed for the optical absorption index to take a maximum value, thereby achieving the optical absorption index of as high as 95.1% in the Example 1. Further, the SiN film thickness assuring a maximum value of the optical absorption index has a difference of as many as approximately 80 nm between incident angles of 0 and 30 degrees, having dependency on the incident angle. As detailed later, this ensures that the optical absorption index in the direction of an incident angle of 0 degree is relatively increased, and the inter-pixel crosstalk is suppressed.

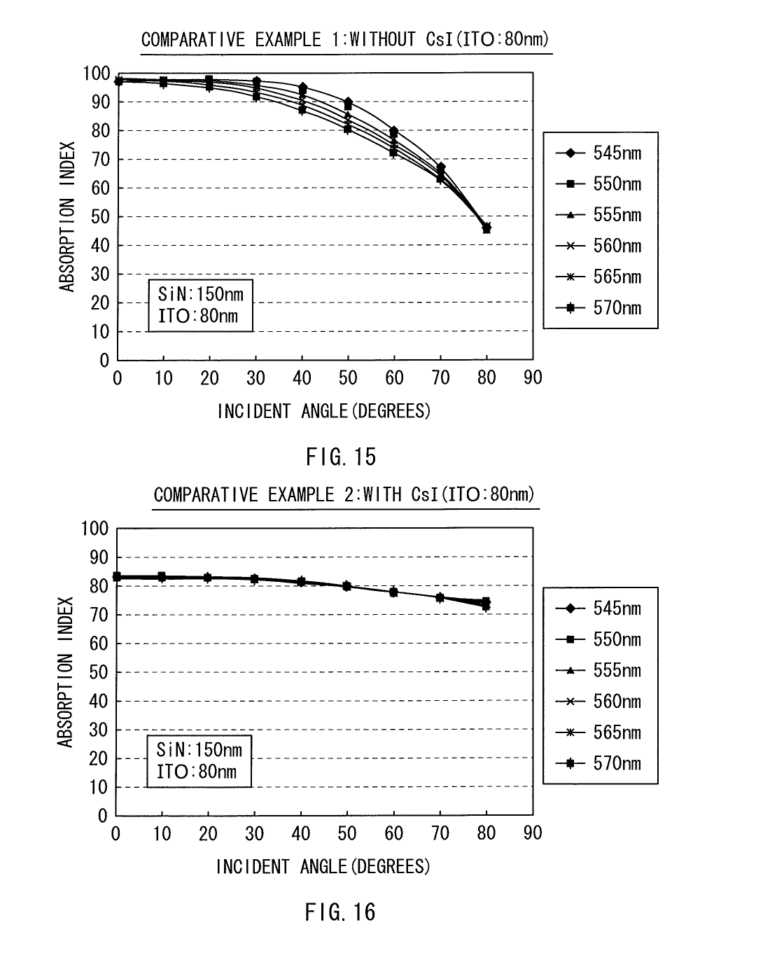

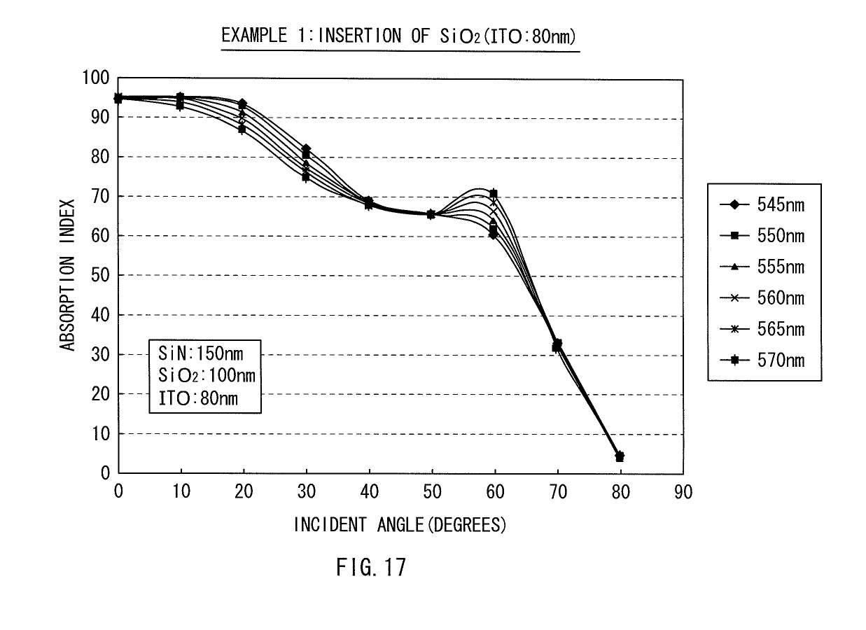

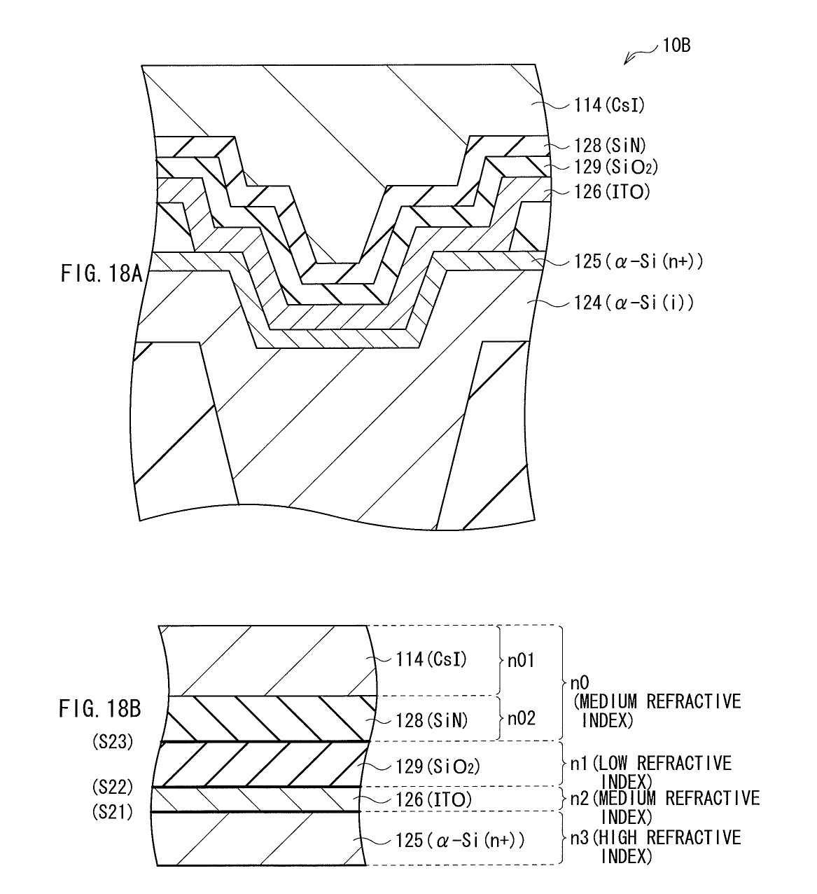

In addition, measurement was also made for the dependency on the incident angle of the optical absorption index as stated above. The results are shown for the comparative example 1 in FIG. 15, for the comparative example 2 in FIG. 16, and for the Example 1 in FIG. 17. As shown in those figures, the Example 1 has greater dependency on the incident angle as compared with the comparative examples 1 and 2. More specifically, the Example 1 exhibits high optical absorption index locally in the vicinity of an incident angle of 0 degree, wherein the optical absorption index is reduced rapidly as an incident angle becomes greater. This allows the optical absorption index especially in the direction of an incident angle of 0 degree to be selectively increased (allows to selectively prevent incident light from the oblique direction from being received) as compared with the comparative examples 1 and 2. Therefore, it is possible to obtain images without any inter-pixel leakage (crosstalk).

Hereinafter, modifications (modifications 1 to 4) for the radiographic image-pickup device according to the above embodiment of the present disclosure are described. It is to be noted that any components essentially same as the radiographic image-pickup device according to the above embodiment of the present disclosure are denoted with the same reference numerals, and the related descriptions are omitted as appropriate.

### <Modification 1>

FIG. 18A shows a laminated structure (laminated structure 10B) in the vicinity of an interface between the photodiode 111A and the scintillator layer 114 on the radiographic image-pickup device according to modification 1. As with the above embodiment of the present disclosure, the laminated structure 10B has the low-refractive-index layer 129 between the n-type semiconductor layer 125 on the photodiode 111A and the scintillator layer 114. In this modification, however, unlike the above embodiment of the present disclosure, the upper electrode 126, the low-refractive-index layer 129, the protective layer 128, and the scintillator layer 114 are provided in this order on the n-type semiconductor layer 125. That is, the laminated structure 10B according to the modification 1 is a structure where the low-refractive-index layer 129 is disposed between the upper electrode 126 and the protective layer 128.

In this modification as well, the refractive indexes of the low-refractive-index layer 129 and other layers on the laminated structure 10B satisfy the above-described conditional equation (1). In this modification, however, the refractive indexes of the scintillator layer 114 and the protective layer 128 are n0 (specifically, n01 or n02), the refractive index of the low-refractive-index layer 129 is n1, that of the upper electrode 126 is n2, and that of the n-type semiconductor layer 125 is n3. For the scintillator layer 114 and the protective layer 128, it is to be noted that the refractive index n0 may satisfy the conditional equation (1) for each of the refractive indexes n01 and n02. In such a structure as well, especially when values of n0 (n01 or n02) and n2 are close relatively, the advantageous effect of providing the low-refractive-index layer 129 is increased.

FIG. 18B shows a material example on each layer in the laminated structure 10B satisfying a relationship of the refractive index as described above, as well as a relative degree (low, medium, high) of the refractive index. As shown in the figure, the n-type semiconductor layer 125 (α-Si (n+)) exhibits high refractive index (n3=4), while the scintillator layer 114 (CsI), the protective layer 128 (SiN), and the upper electrode 126 (ITO) exhibit almost the same medium refractive index (n0=1.77, n21=1.82, and n22=1.73). In this modification, a structure is employed wherein the low-refractive-index layer 129 (SiO₂) exhibiting lower refractive index (n1=1.43) is interposed between such medium refractive index layers (between the protective layer 128 and the upper electrode 126 in this case). As a result, in this modification, light from an interface (S21) between the n-type semiconductor layer 125 and the upper electrode 126 is reflected at an interface (S22) between the upper electrode 126 and the low-refractive-index layer 129, as well as at an interface (S23) between the low-refractive-index layer 129 and the protective layer 128.

Further, as with the laminated structure 10A according to the above embodiment of the present disclosure, when the conditional equation (1) is satisfied in the laminated structure 10B as well, it is presumably desirable that the refractive index (n1) and thickness (d1) of the low-refractive-index layer 129 further satisfy the conditional equation (2). This allows a film thickness of the low-refractive-index layer 129 to be optimized by the efficient use of the optical interference effect, thereby suppressing the deterioration in the optical absorption index.

In this modification, it is presumably more desirable to satisfy the conditional equation (4) given below in addition to the conditional equations (1) and (2). In the conditional equation (4), m′ is an integer, and a thickness of the upper electrode 126 is d2. As described, in the embodiment of the present disclosure, it is more preferable to optimize a film thickness of the upper electrode 126 that is provided between the n-type semiconductor layer 125 and the low-refractive-index layer 129. In the above embodiment of the present disclosure, to achieve a maximum value of the optical absorption index, it is preferable to control film thickness values of a total of three layers including the protective layer 128 and the upper electrode 126 in addition to the low-refractive-index layer 129, but this modification has only to control film thickness values of a total of two layers including the low-refractive-index layer 129 and the upper electrode 126. More specifically, this modification is less susceptible to variations in a film thickness of the protective layer 128, resulting in the process facility being enhanced.

n2×d2=(2m′+1)×(λ/4) (4)

As stated above, in this modification as well, on the laminated structure 10B between the photodiode 111A and the scintillator layer 114, the low-refractive-index layer 129 with the refractive index lower than that each of the scintillator layer 114, the protective layer 128, the upper electrode 126, and the n-type semiconductor layer 125 is provided. Such an arrangement ensures to utilize the optical interference effect efficiently and obtain the same advantageous effects as with the above embodiment of the present disclosure.

### Example 2

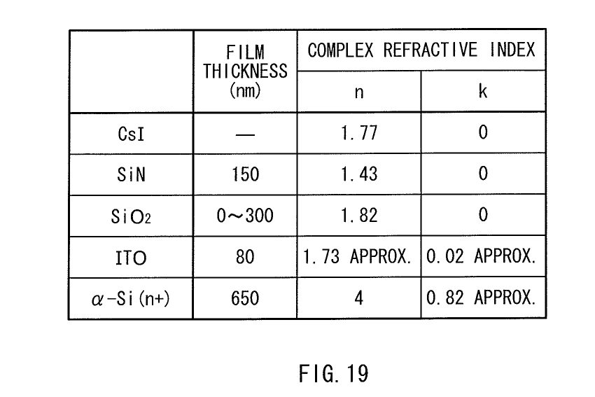

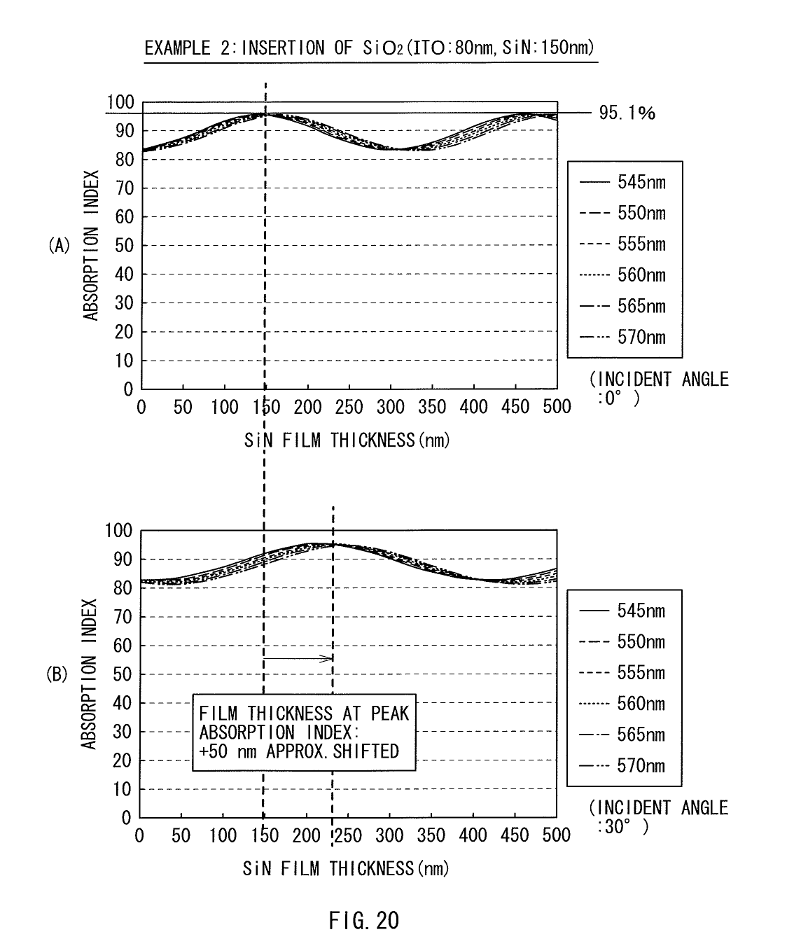

For the laminated structure 10B according to the modification 1 as well, a simulation same as with the above-described Example 1 was carried out. In other words, as Example 2, for the above laminated structure 10B, the optical absorption index was measured with radiation incoming at incident angles of 0 and 30 degrees respectively. FIG. 19 summarizes the conditions for film thickness and refractive index on each layer of the laminated structure 10B used in the Example 2. It is to be noted that, in the Example 2, a film thickness of the low-refractive-index layer 129 (SiO₂) was changed in a range from zero nm to 300 nm, and film thickness values of the ITO and the protective layer 128 (SiN) were 80 nm and 150 nm, respectively. Further, a visible light wavelength was within a range from 545 nm to 570 nm (incremental in 5 nm step). Those results are shown in (A) and (B) of FIG. 20.

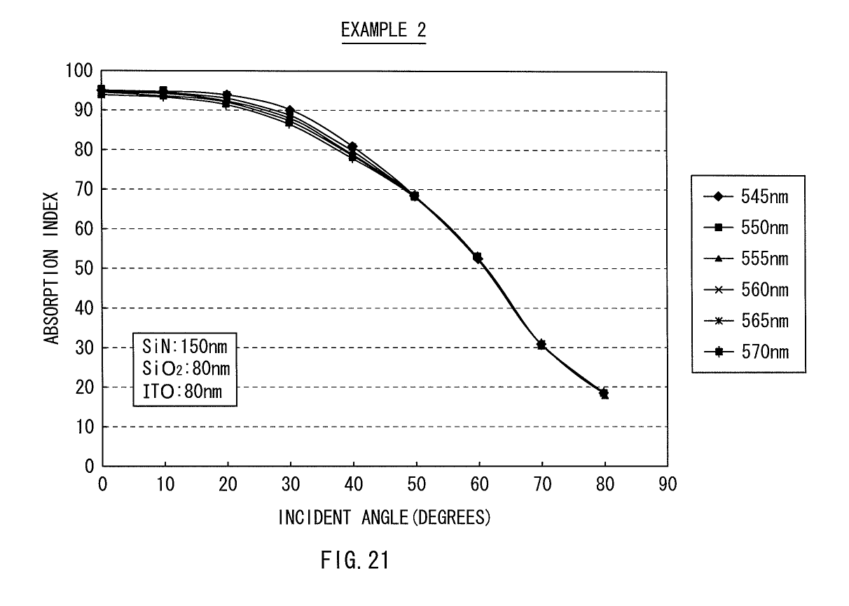

As shown in (A) and (B) of FIG. 20, even when the low-refractive-index layer 129 (SiO₂) is provided between the protective layer 128 and the upper electrode 126, it is seen that the optical absorption index forms a maximum point depending on the SiO₂ film thickness by virtue of the optical interference effect as with the above embodiment of the present disclosure. In other words, it can be seen that optimization of the SiO₂ film thickness is allowed for the optical absorption index to take a maximum value, thereby achieving the optical absorption index of as high as 95.1% in the Example 2. Further, the SiN film thickness assuring a maximum value of the optical absorption index has a difference of as many as approximately 50 nm between incident angles of 0 and 30 degrees, having dependency on the incident angle. This allows the inter-pixel crosstalk to be suppressed. FIG. 21 shows a simulation result of the dependency on the incident angle of the optical absorption index in the Example 2. As shown in the figure, the Example 2 also exhibits high optical absorption index locally in the vicinity of an incident angle of zero degree as with the above-described Example 1, wherein a tendency is seen that the optical absorption index is reduced rapidly as an incident angle becomes greater. Therefore, it is possible to obtain images without any inter-pixel leakage (crosstalk).

### <Modification 2>

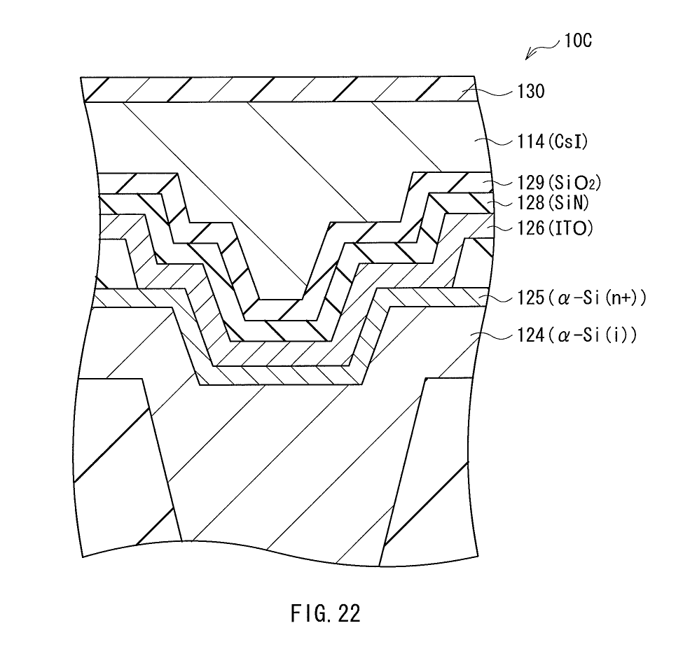

FIG. 22 shows a laminated structure (laminated structure 10C) according to a modification 2. Although the scintillator layer 114 is illustrated as an uppermost layer in the above embodiment and modification 1, a structure may be employed as shown by the laminated structure 10C, where an organic protection film 130 having a moisture barrier function is provided on the scintillator layer 114. The organic protection film 130 is formed of, for example, parylene C (polymonochloro-paraxylene). Because the above-described phosphor material, especially CsI in use for the scintillator layer 114 may deteriorate easily due to moisture, it is preferable that such an organic protection film 130 be provided.

In this modification as well, the refractive indexes of the low-refractive-index layer 129 and other layers on the laminated structure 10C satisfy the above-described conditional equation (1). In this modification, the refractive indexes of the organic protection film 130 and the scintillator layer 114 are n0, the refractive index of the low-refractive-index layer 129 is n1, those of the protective layer 128 and the upper electrode 126 are n2, and that of the n-type semiconductor layer 125 is n3.

### <Modification 3>

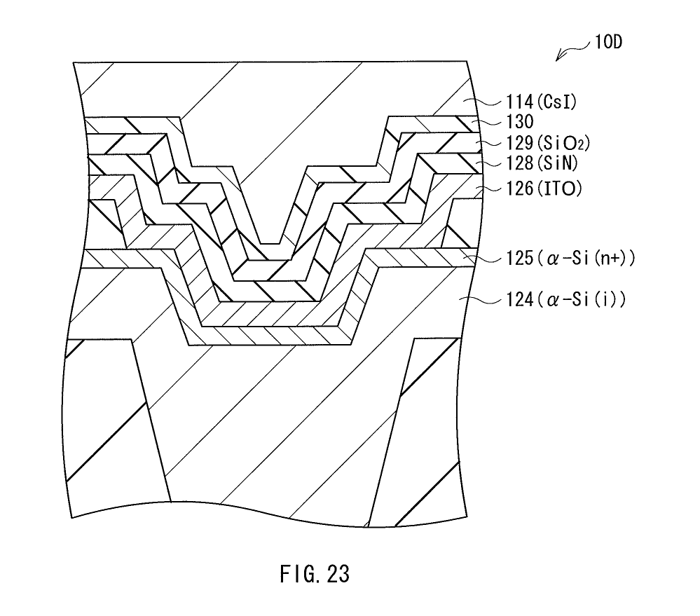

FIG. 23 shows a laminated structure (laminated structure 10D) according to a modification 3. As shown by the laminated structure 10D, the organic protection film 130 may be provided at the underside (surface of a photoelectric conversion layer side) of the scintillator layer 114.

As in the above modifications 2 and 3, the organic protection film 130 for protection against moisture may be provided at the upside or underside of the scintillator layer 114. Even in such a case, if the refractive index of the low-refractive-index layer 129 is lower than that (for example, 1.8) of the organic protection film 130, it is possible to obtain an advantageous effect equivalent to the above embodiment of the present disclosure.

### <Modification 4>

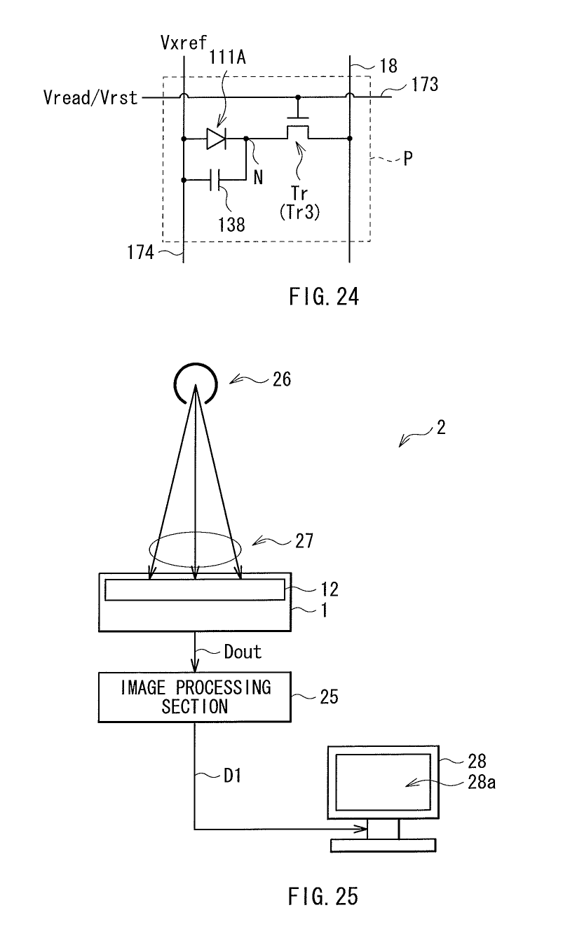

In the above embodiment of the present disclosure, an example where a pixel drive circuit is configured with an active drive circuit is described, but a passive drive circuit as shown in FIG. 24 may be used alternatively. It is to be noted that any components essentially same as the radiographic image-pickup device according to the above embodiment of the present disclosure are denoted with the same references numerals, and the related descriptions are omitted as appropriate. According to this modification, a unit pixel P includes the photodiode 111A, a capacitive component 138, and the transistor Tr (equivalent to the transistor Tr3 for reading). The transistor Tr, which is connected between the storage node N and each of the vertical signal lines 18, outputs a signal charge stored on the storage node N based on the amount of light received at the photodiode 111A to the vertical signal lines 18 by turning on in response to the row scanning signal Vread. In such a manner, a pixel drive scheme is not limited to an active drive scheme described in the above embodiment of the present disclosure, and a passive drive scheme according to this modification may be used alternatively.

### Applicable Example

The radiographic image-pickup device 1 described in the above embodiment and modifications 1 to 4 is applicable to a radiographic image-pickup display system 2 as shown in FIG. 25 for example. The radiographic image-pickup display system 2 includes the radiographic image-pickup device 1, an image processing section 25, and a display unit 28. With such a configuration, on the radiographic image-pickup display system 2, the radiographic image-pickup device 1 obtains image data Dout of a photographic subject 27 on the basis of radiation irradiated from an X-ray source 26 toward the photographic subject 27, and outputs such data to the image processing section 25. The image processing section 25 performs a predetermined image processing for the incoming image data Dout, and then outputs image data (display data D1) subjected to the image processing to the display unit 28. The display unit 28, which has a monitor screen 28a, displays an image based on the display data D1 incoming from the image processing section 25 on the monitor screen 28a.

As stated above, because the radiographic image-pickup display system 2 allows an image of the photographic subject 27 to be obtained as an electric signal on the radiographic image-pickup device 1, it is possible to display an image by transmitting the obtained electric signal to the display unit 28. More specifically, this enables an image of the photographic subject 27 to be observed without using any radiographic film, and allows to handle video photographing and video display as well.

The present disclosure is described hitherto with reference to the embodiment and the modifications, but the present disclosure is not limited to the above embodiments, and is modifiable in various forms. For example, a material and thickness of each layer on the laminated structures 10A to 10D that are described in the above embodiment and the like are not limited to those as stated above, and a variety of materials and thicknesses may be used.

Further, according to the above embodiment of the present disclosure, the photodiode 111A has a structure in which a p-type semiconductor layer, an i-type semiconductor layer, and an n-type semiconductor layer are laminated in this order from a substrate, but alternatively the n-type semiconductor layer, the i-type semiconductor layer, and the p-type semiconductor layer may be laminated in this order from the substrate.

It is possible to achieve at least the following configurations (1) to (15) from the above-described example embodiments, the modifications, and the application examples of the disclosure.

(1) A radiographic image-pickup device, including:

a photoelectric conversion layer;

a wavelength conversion layer provided on the photoelectric conversion layer and converting a wavelength of radiation into a wavelength within a sensitivity band of the photoelectric conversion layer; and

a low-refractive-index layer provided between the photoelectric conversion layer and the wavelength conversion layer, and having a refractive index lower than a refractive index of each of the photoelectric conversion layer and the wavelength conversion layer.

(2) The radiographic image-pickup device according to (1), further including a conductive film provided on the photoelectric conversion layer, wherein the low-refractive-index layer has the refractive index lower than a refractive index of the conductive film.
(3) The radiographic image-pickup device according to (2), further including a protective layer provided on the conductive film, wherein the low-refractive-index layer has the refractive index lower than a refractive index of the protective layer.
(4) The radiographic image-pickup device according to (3), wherein equations (1) and (2) are satisfied:

n0>n1<n2<n3 (1)

n1×d1=(2m+1)×(λ/4) (2)

where a refractive index of a layer provided on a side of the low-refractive-index layer opposite to the photoelectric conversion layer is n0, the refractive index of the low-refractive-index layer is n1, a thickness of the low-refractive-index layer is d1, a refractive index of a layer provided between the low-refractive-index layer and the photoelectric conversion layer is n2, the refractive index of the photoelectric conversion layer is n3, m is an integer, and λ is a wavelength of incident light.

(5) The radiographic image-pickup device according to (4), wherein the conductive film, the protective layer, the low-refractive-index layer, and the wavelength conversion layer are laminated in this order from the photoelectric conversion layer.
(6) The radiographic image-pickup device according to (5), wherein an equation (3) is satisfied:

(n21×d21)+(n22×d22)=(2m′+1)×(λ/4) (3)

where the refractive index and a thickness of the protective layer are n21 and d21 respectively, the refractive index and a thickness of the conductive film are n22 and d22 respectively, and m′ is an integer.

(7) The radiographic image-pickup device according to (4), wherein the conductive film, the low-refractive-index layer, the protective layer, and the wavelength conversion layer are laminated in this order from the photoelectric conversion layer.
(8) The radiographic image-pickup device according to (7), wherein an equation (4) is satisfied:

n2×d2=(2m′+1)×(λ/4) (4)

where the refractive index and a thickness of the conductive film are n2 and d2 respectively, and m′ is an integer.

(9) The radiographic image-pickup device according to (3), further including an organic protection film provided on a surface of the wavelength conversion layer on which the radiation is incident, provided on a surface of the wavelength conversion layer facing the photoelectric conversion layer, or provided on both the surface of the wavelength conversion layer on which the radiation is incident and the surface of the wavelength conversion layer facing the photoelectric conversion layer,

wherein the low-refractive-index layer has the refractive index lower than a refractive index of the organic protection film.

(10) The radiographic image-pickup device according to (1), wherein the wavelength conversion layer includes cesium iodide (CsI).
(11) The radiographic image-pickup device according to (1), wherein the photoelectric conversion layer includes amorphous silicon.
(12) The radiographic image-pickup device according to (1), wherein the low-refractive-index layer includes oxide silicon (SiO₂).
(13) The radiographic image-pickup device according to (2), wherein the conductive film includes indium tin oxide (ITO).
(14) The radiographic image-pickup device according to (3), wherein the protective layer includes silicon nitride (SiN).
(15) A radiographic image-pickup display system with an image-pickup device obtaining a radiation-based image and a display unit displaying the image obtained by the image-pickup device, the image-pickup device including:

a photoelectric conversion layer;

a wavelength conversion layer provided on the photoelectric conversion layer and converting a wavelength of radiation into a wavelength within a sensitivity band of the photoelectric conversion layer; and

a low-refractive-index layer provided between the photoelectric conversion layer and the wavelength conversion layer, and having a refractive index lower than a refractive index of each of the photoelectric conversion layer and the wavelength conversion layer.

The present disclosure contains subject matter related to that disclosed in Japanese Priority Patent Application JP 2011-076516 filed in the Japan Patent Office on Mar. 30, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A radiographic image-pickup device, comprising:
a photoelectric conversion layer;
a wavelength conversion layer provided on the photoelectric conversion layer and converting a wavelength of radiation into a wavelength within a sensitivity band of the photoelectric conversion layer; and
a low-refractive-index layer provided between the photoelectric conversion layer and the wavelength conversion layer, and having a refractive index lower than a refractive index of each of the photoelectric conversion layer and the wavelength conversion layer.

2. The radiographic image-pickup device according to claim 1, further comprising a conductive film provided on the photoelectric conversion layer, wherein the low-refractive-index layer has the refractive index lower than a refractive index of the conductive film.

3. The radiographic image-pickup device according to claim 2, further comprising a protective layer provided on the conductive film, wherein the low-refractive-index layer has the refractive index lower than a refractive index of the protective layer.

4. The radiographic image-pickup device according to claim 3, wherein equations (1) and (2) are satisfied:
n0>n1<n2<n3 (1)
n1×d1=(2m+1)×(λ/4) (2)
where a refractive index of a layer provided on a side of the low-refractive-index layer opposite to the photoelectric conversion layer is n0, the refractive index of the low-refractive-index layer is n1, a thickness of the low-refractive-index layer is d1, a refractive index of a layer provided between the low-refractive-index layer and the photoelectric conversion layer is n2, the refractive index of the photoelectric conversion layer is n3, m is an integer, and λ is a wavelength of incident light.

5. The radiographic image-pickup device according to claim 4, wherein the conductive film, the protective layer, the low-refractive-index layer, and the wavelength conversion layer are laminated in this order from the photoelectric conversion layer.

6. The radiographic image-pickup device according to claim 5, wherein an equation (3) is satisfied:
(n21×d21)+(n22×d22)=(2m′+1)×(λ/4) (3)
where the refractive index and a thickness of the protective layer are n21 and d21 respectively, the refractive index and a thickness of the conductive film are n22 and d22 respectively, and m′ is an integer.

7. The radiographic image-pickup device according to claim 4, wherein the conductive film, the low-refractive-index layer, the protective layer, and the wavelength conversion layer are laminated in this order from the photoelectric conversion layer.

8. The radiographic image-pickup device according to claim 7, wherein an equation (4) is satisfied:
n2×d2=(2m′+1)×(λ/4) (4)
where the refractive index and a thickness of the conductive film are n2 and d2 respectively, and m′ is an integer.

9. The radiographic image-pickup device according to claim 3, further comprising an organic protection film provided on a surface of the wavelength conversion layer on which the radiation is incident, provided on a surface of the wavelength conversion layer facing the photoelectric conversion layer, or provided on both the surface of the wavelength conversion layer on which the radiation is incident and the surface of the wavelength conversion layer facing the photoelectric conversion layer,
wherein the low-refractive-index layer has the refractive index lower than a refractive index of the organic protection film.

10. The radiographic image-pickup device according to claim 1, wherein the wavelength conversion layer includes cesium iodide (CsI).

11. The radiographic image-pickup device according to claim 1, wherein the photoelectric conversion layer includes amorphous silicon.

12. The radiographic image-pickup device according to claim 1, wherein the low-refractive-index layer includes oxide silicon (SiO₂).

13. The radiographic image-pickup device according to claim 2, wherein the conductive film includes indium tin oxide (ITO).

14. The radiographic image-pickup device according to claim 3, wherein the protective layer includes silicon nitride (SiN).

15. A radiographic image-pickup display system with an image-pickup device obtaining a radiation-based image and a display unit displaying the image obtained by the image-pickup device, the image-pickup device comprising:
a photoelectric conversion layer;
a wavelength conversion layer provided on the photoelectric conversion layer and converting a wavelength of radiation into a wavelength within a sensitivity band of the photoelectric conversion layer; and
a low-refractive-index layer provided between the photoelectric conversion layer and the wavelength conversion layer, and having a refractive index lower than a refractive index of each of the photoelectric conversion layer and the wavelength conversion layer.
